(19) United States
(12) Patent Application Publication
(10) Pub. No.: US 2024/0166879 A1
(43) Pub. Date: May 23, 2024

(54) POLYMER BLENDS COMPRISING RECYCLED PLASTICIZER OIL AND RECYCLED GLASS BEADS

(71) Applicant: Avient Corporation, Avon Lake, OH (US)

(72) Inventor: Vishesh NIJHAWAN, Karlsruhe (DE)

(73) Assignee: Avient Corporation, Avon Lake, OH (US)

(21) Appl. No.: 18/551,797

(22) PCT Filed: Mar. 21, 2022
(86) PCT No.: PCT/US2022/021111

§ 371 Date: Sep. 21, 2023

Related U.S. Application Data
(60) Provisional application No. 63/164,826, filed on Mar. 23, 2021.

(51) Int. Cl. C08L 91/00; C08K 3/40

(52) U.S. Cl. CPC C08L 91/00; C08K 3/40; C08L 2207/04; C08L 2207/20; C08L 2207/322

(57) ABSTRACT

Polymer blends include thermoplastic elastomer, recycled plasticizer oil having a viscosity greater than or equal to 20.5 mm²/s at 40° C. and recycled glass beads.

### CLAIM OF PRIORITY

This application claims the benefit of U.S. Provisional Patent Application Ser. No. 63/164,826 bearing Attorney Docket Number 1202101 and filed on Mar. 23, 2021, which is hereby incorporated by reference in its entirety.

### TECHNICAL FIELD

Embodiments of the present disclosure are generally related to polymer blends, and are specifically related to polymer blends comprising thermoplastic elastomer, recycled plasticizer oil, and recycled glass beads.

### BACKGROUND

The world of polymers has progressed rapidly to transform material science from wood and metals of the 19th Century to the use of thermoset polymers of the mid-20th Century to the use of thermoplastic polymers of the later 20th Century. Thermoplastic elastomers (TPEs) combine the benefits of elastomeric properties of thermoset polymers, such as vulcanized rubber, with the processing properties of thermoplastic polymers.

Polymer blends including thermoplastic elastomers are widely used in various applications, such automotive and electronics applications, due to their customizable properties, such as hardness, compression set, color, surface touch, and feel. In an effort to be more sustainable, various industries desire polymer blends that include higher amounts of recycled content. However, the mechanical properties of the polymer blend, such as hardness and compression set, may start to degrade as virgin materials are replaced by recycled materials. Additionally, the recycled materials may contain an undesirable odor. Moreover, the recycled materials may have a black or preexisting color which thereby limits color options for the polymer blend product.

Accordingly, a continual need exists for polymer blends that have increased recycled content while maintaining hardness and compression set as well as reduced odor and color flexibility for the final product.

### SUMMARY

Disclosed herein are polymer blends, which mitigate the aforementioned problems. Specifically, the polymer blends disclosed herein comprise a blend of thermoplastic elastomer, recycled plasticizer oil, and recycled glass beads, which results in a polymer blend having a relatively high recycled content while maintaining hardness and compression set. By including a recycled plasticizer oil having viscosity of greater than or equal to 20.5 mm²/s at 40° C., the hardness and compression set may be maintained as virgin materials are replaced by recycled materials. Moreover, conventional fillers may be replaced by recycled glass beads to maintain the density of the polymer blend while increasing the recycled content.

According to one embodiment, a polymer blend is provided. The polymer blend comprises: thermoplastic elastomer; recycled plasticizer oil having a viscosity greater than or equal to 20.5 mm²/s at 40° C.; and recycled glass beads.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of polymer blends, specifically polymer blends comprising thermoplastic elastomer, recycled plasticizer oil having a viscosity greater than or equal to 20.5 mm²/s at 40° C., and recycled glass beads.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt. %,” as described herein, refers to wt. % based on the weight of the polymer blend, unless otherwise noted.

The term “compression set,” as described herein, refers to the ability of a material to return to its original thickness after prolonged compressive stress as measured according to ISO 815 at the temperature indicated, for example at 23° C. in most cases of the present application.

The term “Shore A Hardness” is a hardness property determined by a durometer according to ISO 7619-1.

As used herein, “odor” is a property evaluated in accordance with the VDA 270 odor test, Method B3 at 80° C.

As used herein, “fogging” is a property evaluated in accordance with DIN 75201.

As used herein, “color” is determined by the naked eye. As discussed in many embodiments, this color may be a natural color that can be colored using a color pigment or a color masterbatch.

The term “viscosity,” as described herein, refers to the kinematic viscosity measured at 40° C. according to DIN EN ISO 3104.

As used herein, “recycled” content is defined in accordance with ISO 14021 and means material recovered from a product or packaging for re-use. Only pre-consumer and post-consumer materials shall be considered as recycled content.

As used herein, “pre-consumer material” or “post-industrial material (PIR)”, which is also defined in accordance with ISO 14021, means material diverted from the waste stream during a manufacturing process. Excluded is reutilization of materials such as rework, regrind or scrap generated in a process and capable of being reclaimed within the same process that generated it.

As used herein, “post-consumer material (PCR)”, which is defined in accordance with ISO 14021, means material generated by households or by commercial, industrial and institutional facilities in their role as end-users of the product, which can no longer be used for its intended purpose. This includes returns of material from the distribution chain.

Further as used herein, “recycled plasticizer oil” is a mixture comprising one or both or PIR and PCR oils. For example, the recycled oil is collected from the waste oil from automobile garages during car service (PCR oil) and waste oil is also collected from metal cutting industries who use oil during their process (PIR). The term “recycled plasticizer oil” may also include re-refined oil. In the case of re-refined oil, used oil may go through a process very similar to the original process of preparing crude oil for use, i.e., filtration, distillation and dehydration.

As used herein, “recycled glass beads” means a mixture of recycled glass beads recovered from one or both of PIR and PCR sources. The term “recycled glass beads” may also be formed from milled and/or glass powder.

Finally, “recycled polymer” means a polymer mixture comprising one or both of PIR and PCR sources.

### Thermoplastic Elastomer

As described hereinabove, the thermoplastic elastomer imparts the desired hardness and compression set required for various applications. These applications may include but are not limited to automotive applications, consumer goods, and electrical and electronic applications.

Various thermoplastic elastomers are considered suitable for the present polymer blends. In embodiments, the thermoplastic elastomer may comprise a styrene copolymer. In embodiments, the styrene copolymer may comprise a styrene-butadiene block copolymer (SBC). In embodiments, the SBC may comprise a styrene-ethylene/butylene-styrene block copolymer (SEBS), a styrene-(ethylene/propylene)-styrene block copolymer (SEEPS), a styrene isoprene block copolymer (SIS), a styrene-isobutylene-styrene block copolymer (SIBS), a styrene-ethylene/polypropylene block copolymer (SEP), a styrene-ethylene/polypropylene-styrene block copolymer (SEPS), or combinations thereof. For example, in embodiments, the styrene copolymer may comprise a SEBS and a SEEPS, a SEBS and a SIS, a SEBS and a SIBS, a SEEPS and a SIS, a SEEPS and a SIBS, a SIS or a SIBS, or even a SEP and a SEPS. Suitable commercial styrene copolymer embodiments may include but are not limited to: CALPRENE 711, an SBS thermoplastic elastomer from Dynasol; CALPRENE H 6174 P, a SEBS thermoplastic elastomer also from Dynasol; and GLOBALPRENE 9551, a SEBS thermoplastic elastomer from LCY Group.

In further embodiments, the thermoplastic elastomer may further comprise thermoplastic polyurethane (TPU), thermoplastic vulcanizate (TPV), thermoplastic polyolefins (TPO), thermoplastic copolyester elastomer (TPC), polyamide thermoplastic elastomer (TPA), thermoplastic styrenic elastomer (TPS), or combinations thereof. Suitable commercial embodiments may include but are not limited to: SANTOPRENE RC 8001, a TPV from Exxon Mobil; and AVALON 85 AE, a TPU from Huntsman.

The thermoplastic elastomer includes a hardness suitable for various applications, for example, consumer product applications (e.g., a grip on shaving razor) and automotive applications. In one or more embodiments, the thermoplastic elastomer may have a Shore A hardness of 95 or less. Moreover, the thermoplastic elastomer may comprise a Shore A hardness from 10 to 95, from 55 to 85, from 60 to 80, from 70 to 80, or any and all sub-ranges formed from these endpoints.

Various amounts are contemplated for the thermoplastic elastomer within the present polymer blends with the proviso being that at least 30 wt. % of the polymer blend includes recycled material. Consequently, the polymer blend may comprise 10 wt. % to 80 wt. %, from 10 wt. % to 80 wt. %, from 10 wt. % to 50 wt. %, from 12 wt. % to 50 wt. %, from 15 wt. % to 60 wt. %, from 15 wt. % to 50 wt. %, or 15 wt. % to 45 wt. % of the thermoplastic elastomer, or any and all sub-ranges formed from any of these endpoints.

### Recycled Plasticizer Oil

In addition to desirably providing improved recyclability of the polymer blend, the recycled plasticizer oil also enables polymer blends to be formulated over a wider hardness range.

In some embodiments, the recycled plasticizer oil may have an impurity level less than 3%. In some embodiments, the impurity may comprise dimethyl sulfoxide (DMSO). Without being limited by theory, the recycled plasticizer oil may comprise a mixed stream of recycled oils, which can lead to contamination. For conventional recycled plasticizer oils, the cost of separating or segregating this contamination is often not feasible, and the combination of multiple oils may result in incompatibilities that reduce the mechanical properties as well as degrade the color and impart a foul odor.

However, the present recycled plasticizer oils address these issues and do not degrade the hardness, and no color or odor is added due to the inclusion of this recycled plasticizer oil. Here, the recycled plasticizer oil may be derived by collecting oils from different recycled waste oil streams as described above, broken down into small molecules and re-synthesized into plasticizer oil of suitable quality. In embodiments, it is desirable that the recycled plasticizer oil is a colorless and odorless hydrocarbon oil. In one or embodiments, the recycled plasticizer oil consists of hydrocarbon oils thereby excluding non-hydrocarbon oils (e.g., silane containing oils) in the recycled plasticizer oil. Various hydrocarbon oil compositions are considered as suitable in the recycled plasticizer oil. For example, the recycled plasticizer oil comprises paraffinic oil. In one or embodiments, the recycled plasticizer oil comprises at least 90 wt. %, at least 95 wt. %, or at least 99 wt. % paraffinic oil.

The paraffinic oil present in the recycled plasticizer oil may include long alkane carbon chains of C₂₀ to C₅₀ carbons. In embodiments, the paraffinic comprises at least 90 wt. %, at least 95 wt. %, or at least 99 wt. % of C₂₀ to C₅₀ carbon chains. Suitable recycled plasticizer oils may be classified under CAS no. 64742-54-7 or CAS no. 8042-47-5. Furthermore, suitable commercial embodiments of the recycled plasticizer may include but are not limited to: SIP DP 1033-44R from SIP Specialty Oils and Fluids; and SYNACOL T45 from Puraglobe.

Additionally, in further embodiments, the recycled plasticizer oil may have a density from 0.80 g/cm³ to 0.90 g/cm³, from 0.82 g/cm³ to 0.87 g/cm³, or from 0.84 g/cm³ to 0.86 g/cm³ at 15° C. when measured according to DIN 51757.

In one or more embodiments, the recycled plasticizer oils may be a natural color. As used herein, “natural color” means that it can be colored using a color pigments or a color masterbatch.

As stated above, the recycled plasticizer oil has a viscosity of at least 20.5 mm²/s at 40° C. as measured according to DIN EN ISO 3104. In further embodiments, the recycled plasticizer oil may have a viscosity of at least 25 mm²/s, or at least 30 mm²/s, or at least 35 mm²/s, or at least 40 mm2/s at 40° C. Said another way, the recycled plasticizer oil may have, in other embodiments, a viscosity of 21 to 60 mm²/s, or from 21 to 50 mm²/s, or from 25 to 45 mm²/s, or from 35 to 45 mm²/s at 40° C. By having a viscosity above 20.5 mm²/s and a DMSO impurity level below 3 wt. %, the present recycled plasticizer oils may be considered as a non-hazardous hydrocarbon oil according to the European Chemical Agency (ECHA).

Various amounts of recycled plasticizer oil are contemplated depending on the formulation requirements. In one or more embodiments, the polymer blend may comprise from 5 wt. % to 70 wt. %, from 5 wt. % to 55 wt. %, from 10 wt. % to 50 wt. %, from 12 wt. % to 70 wt. %, from 12 wt. % to 40 wt. % of recycled plasticizer oil, or from 25 wt. % to 35 wt. % of recycled plasticizer oil.

### Recycled Glass Beads

Within the polymer blend, the recycled solid glass beads act as the filler, and increase the density of the polymer blend. Also, the recycled glass beads reduce the total content of petroleum based polymers in the polymer blend and increase sustainability by adding to the amount of recycled material in the polymer blend, while helping ensure that the mechanical properties of the polymer blend is maintained.

Various recycled glass bead structures are considered suitable. In one or more embodiments, the recycled glass beads may comprise granular, rounded, or spherical beads. In this embodiment, it is contemplated that at least 60 wt. %, at least 70 wt. %, or at least 80 wt. % of the glass beads would be rounded or spherical. Moreover, the recycled glass beads may comprise solid or hollow beads; however, most embodiments described herein utilize solid beads.

From a size standpoint, the recycled glass beads may have a diameter from 1 μm to 71 μm, or from 1 μm to 50 μm. In some embodiments, this diameter range means that at least 80% by volume, at least 90%, or at least 95% of the recycled glass beads have a diameter in those size ranges.

As stated above, adding more recycled glass beads to increase the recycle content in the polymer blend may have numerous benefits (e.g., reduced petroleum based polymers). In one or more embodiments, the polymer blend may comprise from 5 wt. % to 50 wt. %, 5 wt. % to 45 wt. %, from 10 wt. % to 45 wt. %, from 10 wt. % to 4 wt. %, or from 30 wt. % to 40 wt. % of recycled glass beads.

In addition to the component ranges provided above, additional embodiments of the polymer blend are provided to include further detail. For example, in one embodiment, the polymer blend may comprise: 10 wt. % to 85 wt. % of thermoplastic elastomer; 5 wt. % to 70 wt. % of recycled plasticizer oil; and 5 wt. % to 50 wt. % of recycled glass beads. In another embodiment, the polymer blend may comprise: 10 wt. % to 30 wt. % of thermoplastic elastomer; 20 wt. % to 40 wt. % of recycled plasticizer oil; and 25 wt. % to 45 wt. % of recycled glass beads.

Additionally, the present polymer blends may comprise at least 30% recycled content, which may include the recycled plasticizer oil, the recycled glass beads, and the optional recycled thermoplastic polymer as detailed below. In further embodiments, the polymer blend may comprise 30 wt. % to 90 wt. %, from 45 wt. % to 90 wt. %, from 50 wt. % to 90 wt. %, from 60 wt. % to 90 wt. %, from 70 wt. % to 90 wt. %, or from 80 wt. % to 90 wt. % recycled content. Without being bound by theory, it was surprising to achieve a polymer blend with almost half to significant more than half of recycled content without sacrificing mechanical properties (e.g., hardness and compressive set), and color. Suitable commercial embodiments may include SPHERASTEK recycled glass beads from Donroad.

### Additional Components

Optionally, the polymer blend may further comprise recycled thermoplastic polymer. Without being bound by theory, the recycled thermoplastic polymer may adjust the amount of recycled content and also change the hardness of the thermoplastic elastomer. Virgin thermoplastic polymer (e.g., virgin polypropylene, high density polyethylene (HDPE), or linear low density polyethylene (LLDPE)) may also be used to adjust hardness; however, this addition undesirably reduces the percentage of recycled content in the polymer blend.

Various recycled thermoplastic polymers are considered suitable. In one embodiment, the recycled thermoplastic polymer comprises recycled polypropylene. In one or more embodiments, the polymer blend may comprise 1 to 50 wt. %, from 5 wt. % to 35 wt. %, from 5 wt. % to 30 wt. %, or from 5 wt. % to 15 wt. % of recycled thermoplastic polymer.

In other embodiments, the polymer blend may further comprise various additives. In embodiments, the additives may comprise antioxidants; adhesion promoters; biocides; anti-fogging agents; anti-static agents; blowing and foaming agents; bonding agents and bonding polymers; dusting agents; dispersants; flame retardants and smoke suppressants; mineral fillers; initiators; lubricants; micas; pigments, colorants, and dyes; processing aids; release agents; slip and anti-blocking agents; stearates; ultraviolet light absorbers; viscosity regulators; waxes; or combinations thereof.

In embodiments, the amount of additive in the polymer blend may be greater than 0 wt. %, greater than or equal to 0.25 wt. %, greater than or equal to 0.5 wt. %, greater than or equal to 1 wt. %, or even greater than or equal to 2 wt. %. In embodiments, the amount of additives in the polymer blend may be less than or equal to 35 wt. %, less than or equal to 20 wt. %, less than or equal to 10 wt. %, or even less than or equal to 50 wt. %. In embodiments, the amount of the additive in the polymer blend may be from 0 wt. % to 35 wt. %, from 0 wt. % to 20 wt. %, from 0 wt. % to 10 wt. %, from 0 wt. % to 5 wt. %, from 0.25 wt. % to 35 wt. %, from 0.25 wt. % to 20 wt. %, from 0.25 wt. % to 10 wt. %, from 0.25 wt. % to 5 wt. %, from 0.5 wt. % to 35 wt. %, from 0.5 wt. % to 20 wt. %, from 0.5 wt. % to 10 wt. %, from 0.5 wt. % to 5 wt. %, from 1 wt. % to 35 wt. %, from 1 wt. % to 20 wt. %, from 1 wt. % to 10 wt. %, from 1 wt. % to 5 wt. %, from 2 wt. % to 35 wt. %, from 2 wt. % to 20 wt. %, from 2 wt. % to 10 wt. %, or even from 2 wt. % to 5 wt. %, or any and all sub-ranges formed from any of these endpoints.

### Properties of the Polymer Blend

As stated above, hardness is a key property of the present polymer blends. In one or more embodiments, the polymer blend may have a Shore A hardness greater than or equal to 10 and less than or equal to 95. In embodiments, the polymer blend may have a Shore A hardness greater than or equal to 10, greater than or equal to 20, greater than or equal to 25, greater than or equal to 30. In embodiments, the polymer blend may have a Shore A hardness from 25 to 80, or from 30 to 70. Moreover, the polymer blend may have a compression set greater than or equal to 10% and less than or equal to 45% as measured in accordance with ISO 815 at 23° C., or a compression set greater than or equal to 15% and less than or equal to 45%.

In addition to maintaining hardness, the recycled glass beads and recycled plasticizer oil do not appreciably degrade the color and odor properties of the polymer blend. For example, the polymer blend has an odor less than or equal to 3 as measured in accordance with VDA 270, which is only a marginal increase and thereby would not be considered an unacceptable nuisance to the consumer. Moreover, the color is maintained for the polymer blend. As stated above, this may be attributed in some embodiments to the color masterbatches or color pigments described above.

### Method of Making

In one or more embodiments, the polymer blends described herein may be made by batch mixing followed by a continuous compounding process that takes place in an extruder at an elevated temperature (e.g., 160° C.-220° C.) that is sufficient to melt the polymer matrix. The mixing speeds may range from 60 to 1000 rpm and temperature of mixing can be ambient. Screw speed inside an extruder can range from about 50 to about 700 revolutions per minute (rpm), and preferably from about 100 to about 400 rpm. In embodiments, the output from the extruder is pelletized for later extrusion, molding, thermoforming, foaming, calendaring, and/or other processing into polymeric articles.

### EXAMPLES

Table 1 shows sources of ingredients for the polymer blends of the Comparative and Inventive Examples detailed below.

TABLE 1

| Ingredient | Brand | Source | Properties |
|---|---|---|---|
| Styrene-butadiene-styrene | CALPRENE 711 | Dynasol | Shore A Hardness = 80 |
| copolymer (SBS) | | | |
| Styrene- | CALPRENE H 6174 P | Dynasol | Shore A Hardness = 76 |
| ethylene/butylene-styrene | | | |
| block copolymer (SEBS) | | | |
| Styrene- | GLOBALPRENE 9551 | LCY Group | Shore A Hardness = 75 |
| ethylene/butylene-styrene | | | |
| block copolymer (SEBS) | | | |
| Thermoplastic | SANTOPRENE RC 8001 | Exxon Mobil | Shore A Hardness = 55 |
| vulcanizate (TPV) | | | |
| Thermoplastic | AVALON 85 AE | Huntsman | Shore A Hardness = 85 |
| polyurethane (TPU) | | | |
| Virgin plasticizer | PIONIER M 1930 | H&R Group | Kinematic Viscosity = |
| (white mineral oil | EXTRA | | 71.42 mm²/s |
| (petroleum)) | | | |
| Recycled plasticizer | SIP DP 1033-44R | SIP | Kinematic Viscosity = |
| (hydrotreated heavy | | | 44 mm²/s |
| parafinic distillate | | | |
| (petroleum) | | | |
| Recycled plasticizer | SYNACOL T45 | Puraglobe | Kinematic Viscosity = |
| (hydrotreated heavy | | | 44.9 mm²/s |
| paraffinic distillate | | | |
| (petroleum) | | | |
| Filler | Omy aCarb 5-GU | Omya | D98 = 24 microns |
| (calcium carbonate) | | | |
| Filler | Omy aCarb 5-BE | Omya | D98 = 24 microns |
| (calcium carbonate) | | | |
| Recycled filler | SPHERASTEK | Donroad | D90 = 50 microns |
| (solid glass beads) | (1-50 MU 4002) | | At least 80% round |
| Polypropylene (PP) | 100-GB06 | INEOS | Melt Flow Rate (230 |
| | | | C/2.16 kg) = 6 g/10 min |
| Recycled polypropylene | PP REGRANULATE | Vogt-Plastic | Melt Flow Rate (230 |
| (PP) | 500-S | | C/2.16 kg) = |
| Recycled polypropylene | ECOPROP PPH-PPC | Tivaco | Melt Flow Rate (230 |
| (PP) | NATURAL 60 | | C/2.16 kg) = 60 g/10 min |
| Hydrocarbon resin | KRISTALEX 5140 | Eastman | — |
| Epoxy resin | EPON 1004 F | Miller-Stephenson | — |
| Dusting agent | Steamic 00S F | IMCD | — |
| (amorphous silica | | | |
| polycode) | | | |
| Carbon black color | FDM BLACK | Avient | — |
| masterbatch | BATHENE PP-8027 | | |
| Curing agent | EPIKOTE RESIN MGS | Hexion | — |
| | LR235 | | |
| Antioxidant | ANTIOXIDANT 1010 | Akrochem Corporation | — |
| tetrakis [methylene (3,5- | | | |
| di-ter-butyl-4- | | | |
| hydroxyhydrocinnamate)] | | | |
| methane | | | |
| Antioxidant and stabilizer | Eunox AO-565 | Eutec Chemical Co., Ltd. | — |
| Stabilizer | IRGAFOS 168 | BASF | — |
| Slip agent | INCROSLIP | Croda Polymer Additives | — |
| Antiblockingagent | Strktol TR131 | Ciba | — |
| (erucamide) | | | |
| Compatibilizer | SCONA TSKD 9103 | BYK | — |
| Additive | Tinuvin 326 | BASF | — |
| Additive | MileOx 549 | MPI Chemie BV | — |

### Process for Making the Polymer Blends

Referring to Table 2-4 below, the comparative polymer blends (C1-C4) and inventive polymer blends (E1-E4) were prepared by batch mixing in a mixer at ambient temperature. Followed by adding the components into a Leistritz ZSE 27 MX twin screw extruder. The extruder temperatures progressed across the extruder zones at a temperature range of 160-210° C. The extrusion screw speed was 320 RPM. The extruder output were pellets, which were then molded into tensile test bars using an Arburg injection molding machine, operating at 160-180° C. temperature.

TABLE 2

| Example | C1 | E1 |
|---|---|---|
| CALPRENE 711 | 13.2 | 13.2 |
| GLOBALPRENE 9551 | 6.85 | 6.9 |
| SANTOPRENE RC 8001 | 4.9 | 4.9 |
| PIONIER M 1930 EXTRA | 29.45 | — |
| SIP DP 1033-44R | — | 29.5 |
| Omy aCarb 5-GU | 33.4 | — |
| SPHERA STEK | — | 33.3 |
| KRISTALEX 5140 | 10.3 | 10.3 |
| EPON 1004 F | 0.5 | 0.5 |
| Steamic 00S F | 0.2 | 0.2 |
| Eunox AO-565 | 0.25 | 0.25 |
| IRGAFOS 168 | 0.25 | 0.25 |
| Strktol TR131 | 0.1 | 0.1 |
| Tinuvin 326 | 0.2 | 0.2 |
| MileOx 549 | 0.4 | 0.4 |
| Recycled content | 0 | 62.8 |
| Density (g/cm³) | 1.190 | 1.145 |
| Hardness (Shore A) | 35 | 35 |
| Color | Natural | Natural |
| Odor | — | — |
| Viscosity | — | 8.9 |
| Fogging | — | — |

As shown in Table 2 above, polymer blends C1 and E1 both included the same combination of thermoplastic elastomer—SBS (Calprene 711), SEBS (GLOBALPRENE 951) and TPV (SANTOPRENE RC 8001). In contrast, C1 included virgin plasticizer (PIONIER M 1930 EXTRA), whereas E1 included recycled plasticizer oil (SIP DP 1033-44R). Similarly, C1 included calcium carbonate filler (OmyaCarb 5-GU), whereas E1 included recycled glass beads (SPHERASTEK). As shown, E1 included 62.8% recycled content yet achieved the same Shore A Hardness as the C1 example, which did not include any recycled material. Moreover, the color was natural in the E1 example despite the fact that it included 62.8% recycled content. Accordingly, the E1 polymer utilized a majority of recycled material while still achieving the desired hardness and color achieved by a purely virgin polymer blend C1.

TABLE 3

| Example | C2 | E2 |
|---|---|---|
| CALPRENE H 6174 P | 15.2 | 15.2 |
| PIONIER M 1930 EXTRA | 31.9 | — |
| SIP DP 1033-44R | — | 31.9 |
| Omy aCarb 5-BE | 39.0 | — |
| SPHERA STEK | — | 39.0 |
| 100-GB06 | 12.9 | — |
| PP REGRANULATE 500-S | — | 12.9 |
| Steamic 00S F | 0.2 | 0.2 |
| EPIKOTE RESIN MGS LR235 + | 0.8 | 0.8 |
| ANTIOXIDANT 1010 | | |
| Recycled content | 0 | 83.8 |
| Density (g/cm³) | 1.209 | 1.157 |
| Hardness (Shore A) | 66 | 65 |
| Compression set (%) (23° C.) | 29 | 35 |
| Color | Natural | Natural |
| Odor (80° C.) | 3 | 3 |
| Fogging (mg) | 1.3 | — |

As shown in Table 3 above, polymer blends C2 and E2 both included the same thermoplastic elastomer—SEBS (CALPRENE H 6174 P). In contrast, C2 included virgin plasticizer (PIONIER M 1930 EXTRA), whereas E2 included recycled plasticizer oil (SIP DP 1033-44R). Similarly, C2 included calcium carbonate filler (OmyaCarb 5-BE), whereas E2 included recycled glass beads (SPHERASTEK). Finally, C2 included virgin polypropylene (100-GB06) whereas E2 included recycled polypropylene (PP REGRANULATE 500-S). As shown, E2 included 83.8% recycled content yet achieved substantially the same Shore A Hardness as the C2 example, which did not include any recycled material. Furthermore, E2 demonstrated a slight improvement in compression set relative to the virgin C2 polymer blend. Moreover, the color was natural in the E2 example despite the fact that it included 83.8% recycled content. While there was an increase in odor for the E2 polymer blend, the recorded odor value of 3 was insignificant. Accordingly, the E2 polymer utilized over 80 wt. % recycled material while still achieving the desired hardness and color achieved by a purely virgin polymer blend C2. Also, as shown, polymer blend C2 had an odor value of 3 as tested by VDA 270—Method B3 at 80° C. whereas E2 had an odor value of 3. Polymer blend C2 also had a fogging value of 1.3 mg as generated by test method DIN 75201.

TABLE 4

| Example | C3 | E3 | C4 | E4 |
|---|---|---|---|---|
| CALPRENE H 6174 P | 17.9 | 17.9 | 15.2 | 15.2 |
| PIONIER M 1930 EXTRA | 34.1 | — | 31.8 | — |
| SYNACOL T45 | — | 34.1 | — | 31.8 |
| Omy aCarb 5-BE | 38.0 | — | 39.0 | — |
| SPHERASTEK | — | 38.0 | — | 39.0 |
| 100-GB06 | 9.0 | — | 13.0 | — |
| ECOPROP PPH-PPC | — | 9.0 | — | 13.0 |
| NATURAL 60 | | | | |
| Steamic 00S F | 0.2 | 0.2 | 0.2 | 0.2 |
| EPIKOTE RESIN MGS LR235 + | 0.8 | 0.8 | 0.8 | 0.8 |
| ANTIOXIDANT 1010 | | | | |
| Recycled content | 0 | 81.1 | 0 | 83.8 |
| Density (g/cm³) | 1.190 | 1.162 | 1.203 | 1.165 |
| Hardness (Shore A) | 61 | 53 | 73 | 67 |
| Compression set (%) (23° C.) | 23 | 24 | 29 | 37 |
| Color | Natural | Natural | Natural | Natural |
| Odor (80° C.) | — | 3 | — | 2.5 |
| Fogging (mg) | — | 0.9 | — | 0.55 |

As shown in Table 4 above, polymer blends C3 and E3 both included the same thermoplastic elastomer—SEBS (CALPRENE H 6174 P). In contrast, C3 included virgin plasticizer (PIONIER M 1930 EXTRA), whereas E3 included recycled plasticizer oil (SYNACOL T45). Similarly, C3 included calcium carbonate filler (OmyaCarb 5-BE), whereas E3 included recycled glass beads (SPHERASTEK). Finally, C3 included virgin polypropylene (100-GB06) whereas E3 included recycled polypropylene (ECOPROP PPH-PPC NATURAL 60). As shown, E3 included 81.1% recycled content yet only achieved a marginally lower Shore A Hardness relative to the C3 example, which did not include any recycled material. Furthermore, E3 demonstrated a slight improvement in compression set relative to the virgin C3 polymer blend. Moreover, the color was natural in the E3 example despite the fact that it included 81.1% recycled content. While there was an increase in odor for the E3 polymer blend, the recorded odor value of 3 was insignificant. Accordingly, the E3 polymer utilized over 80 wt. % recycled material while still achieving the desired hardness and color achieved by a purely virgin polymer blend C3.

Moreover, as shown in Table 4 above, polymer blends C4 and E4 both included the same thermoplastic elastomer—SEBS (CALPRENE H 6174 P). In contrast, C4 included virgin plasticizer (PIONIER M 1930 EXTRA), whereas E4 included recycled plasticizer oil (SYNACOL T45). Similarly, C4 included calcium carbonate filler (OmyaCarb 5-BE), whereas E4 included recycled glass beads (SPHERASTEK). Finally, C4 included virgin polypropylene (100-GB06) whereas E4 included recycled polypropylene (ECOPROP PPH-PPC NATURAL 60). As shown, E4 included 83.8% recycled content yet only achieved a marginally lower Shore A Hardness relative to the C4 example, which did not include any recycled material. Furthermore, E4 demonstrated a slight improvement in compression set relative to the virgin C4 polymer blend. Moreover, the color was natural in the E4 example despite the fact that it included 83.8% recycled content. While there was an increase in odor for the E4 polymer blend, the recorded odor value of 2.5 was insignificant. Accordingly, the E4 polymer utilized over 80 wt. % recycled material while still achieving the desired hardness and color achieved by a purely virgin polymer blend C4.

Also, as shown, polymer blend E3 had an odor value of 3 as tested by VDA 270—Method B3 at 80° C. and E4 had an odor value of 2.5. Polymer blend E3 also had a fogging value of 0.9 mg and E4 had a fogging value of 0.55 mg as generated by test method DIN 75201.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

What is claimed is:

1. A polymer blend comprising:
(a) thermoplastic elastomer;
(b) recycled plasticizer oil having a viscosity greater than or equal to 20.5 mm²/s at 40° C.; and
(c) recycled glass beads.

2. The polymer blend of claim 1, wherein the polymer blend comprises:
(a) 10 wt. % to 85 wt. % of the thermoplastic elastomer;
(b) 5 wt. % to 70 wt. % of the recycled plasticizer oil; and
(c) 5 wt. % to 50 wt. % of the recycled glass beads.

3. The polymer blend of claim 1, wherein the recycled plasticizer oil has an impurity level less than 3%, wherein the impurity comprises dimethyl sulfoxide.

4. The polymer blend of claim 1, wherein the polymer blend comprises 15 wt. % to 60 wt. % of the thermoplastic elastomer.

5. The polymer blend of claim 1, wherein the thermoplastic elastomer comprises styrene-butadiene-styrene copolymer (SBS), styrene-ethylene/butylene-styrene block copolymer (SEBS), thermoplastic vulcanizate (TPV), thermoplastic polyurethane (TPU), thermoplastic copolyester elastomer (TPC), or a combination thereof.

6. The polymer blend of claim 1, wherein the polymer blend comprises 5 wt. % to 55 wt. % of the recycled plasticizer oil.

7. The polymer blend of claim 1, wherein the recycled plasticizer oil comprises paraffinic oil.

8. The polymer blend of claim 1, wherein the recycled plasticizer oil has a density from 0.82 g/cm³ to 0.87 g/cm³.

9. The polymer blend of claim 1, wherein the recycled plasticizer oil has a viscosity from 20.5 mm²/s to 57 mm²/s at 40° C.

10. The polymer blend of claim 1, wherein the polymer blend comprises 5 wt. % to 45 wt. % of the recycled glass beads.

11. The polymer blend of claim 1, wherein the recycled glass beads have a diameter from 1 μm to 71 μm.

12. The polymer blend of claim 1, wherein the recycled glass beads comprise round beads.

13. The polymer blend of claim 1, wherein the recycled glass beads are solid.

14. The polymer blend of claim 1, wherein the polymer blend further comprises 1 wt. % to 40 wt. % of the recycled thermoplastic polymer.

15. The polymer blend of claim 14, wherein the recycled thermoplastic polymer comprises recycled polypropylene.

16. The polymer blend of claim 1, wherein the polymer blend further comprises virgin thermoplastic polymer, wherein the virgin thermoplastic polymer comprises polypropylene (PP), high density polyethylene (HDPE), linear low density polyethylene (LLDPE), or combinations thereof.

17. The polymer blend of claim 1, wherein the polymer blend has a recycled content from 45 wt. % to 90 wt. %, wherein the recycled content comprises the recycled glass beads, the recycled plasticizer oil, and optional recycled polymer.

18. The polymer blend of claim 1, wherein the polymer blend has a Shore A hardness greater than or equal to 10 and less than or equal to 95.

19. The polymer blend of claim 1, wherein the polymer blend has a compression set greater than or equal to 10% and less than or equal to 45% as measured in accordance with ISO 815 at 23° C.

20. The polymer blend of claim 1, wherein the polymer blend has an odor less than or equal to 3 as measured in accordance with VDA 270.

21. The polymer blend of claim 1, wherein the polymer blend has a fogging value less than 2.0 mg as measured in accordance with DIN 75201.
